(19) United States
(12) Patent Application Publication
(10) Pub. No.: US 2026/0099599 A1
(43) Pub. Date: Apr. 9, 2026

(54) CLOUD DATA EXTRACTION IN HIGH-SECURITY CONTEXTS

(71) Applicant: Truist Bank, Charlotte, NC (US)

(72) Inventors: Nagaraja Hebbar, Charlotte, NC (US); Matthew Stowell, Charlotte, NC (US)

(73) Assignee: Truist Bank, Charlotte, NC (US)

(21) Appl. No.: 18/911,723

(22) Filed: Oct. 10, 2024

Related U.S. Application Data
(63) Continuation of application No. 18/910,564, filed on Oct. 9, 2024.

(51) Int. Cl. G06F 21/56; G06F 21/55; G06F 21/60

(52) U.S. Cl. CPC G06F 21/565; G06F 21/554; G06F 21/602

(57) ABSTRACT

In one example, a local computing environment can determine a total number of records that are in a batch of records stored in a cloud computing environment. The local computing environment can also determine a set of subgroups of records contained within the batch of records. The local computing environment can then execute a partitioned retrieval process that involves spawning and executing processing threads, where each of the processing threads retrieves one or more of the subgroups from the cloud computing environment and saves them to one or more files. The partitioned retrieval process can then be validated at least in part by determining whether the number of records stored in the files matches the total number of records in the batch.

### CROSS-REFERENCE TO RELATED APPLICATIONS

The present application is a continuation of U.S. application Ser. No. 18/910,564, filed Oct. 9, 2024, titled “CLOUD DATA EXTRACTION IN HIGH-SECURITY CONTEXTS,” the entirety of which is incorporated herein by reference.

### TECHNICAL FIELD

The present disclosure relates generally to cloud computing environments. More specifically, but not by way of limitation, this disclosure relates to extracting data from a cloud computing environment to a local computing environment in a high-security context.

### BACKGROUND

Cloud computing environments have grown in popularity due to their flexibility, scalability, efficiency, and reliability. It is increasingly common for users to offload heavy processing loads from their local computing environments to remote cloud computing environments, which can flexibly adapt to handle such heavy processing loads. Users may also offload data storage to cloud computing environments, which can scale in size to store a virtually unlimited amount of data.

### SUMMARY

One example of the present disclosure includes a non-transitory computer-readable medium comprising program code that is executable by one or more processors of a local computing environment for causing the one or more processors to perform operations including. The operations can include transmitting a first request to a cloud computing environment, the first request being for a total number of records in a batch of records that was processed by the cloud computing environment during a prior time window. The operations can include receiving a first response to the first request, the first response indicating the total number of records in the batch of records. The operations can include transmitting a second request to the cloud computing environment, the second request being for a list of subgroups of records contained within the batch of records. The operations can include receiving a second response to the second request, the second response including the list of subgroups of records. The operations can include executing a partitioned retrieval process for the batch of records, wherein the partitioned retrieval process involves: spawning a number of processing threads in the local computing environment; and operating the processing threads in parallel, such that each of the processing threads retrieves one or more of the subgroups of records from the cloud computing environment and saves the one or more subgroups of records to one or more files in the local computing environment. The operations can include validating the partitioned retrieval process by determining whether a number of records stored in the one or more files matches the total number of records in the batch of records.

Another example of the present disclosure includes a computer-implemented method of operations. The operations can include transmitting a first request to a cloud computing environment, the first request being for a total number of records in a batch of records that was processed by the cloud computing environment during a prior time window. The operations can include receiving a first response to the first request, the first response indicating the total number of records in the batch of records. The operations can include transmitting a second request to the cloud computing environment, the second request being for a list of subgroups of records contained within the batch of records. The operations can include receiving a second response to the second request, the second response including the list of subgroups of records. The operations can include executing a partitioned retrieval process for the batch of records, wherein the partitioned retrieval process involves: spawning a number of processing threads; and operating the processing threads in parallel, such that each of the processing threads retrieves one or more of the subgroups of records from the cloud computing environment and saves the one or more subgroups of records to one or more files. The operations can include validating the partitioned retrieval process by determining whether a number of records stored in the one or more files matches the total number of records in the batch of records.

Yet another example of the present disclosure can include a system comprising one or more processors and one or more memories. The one or more memories can include instructions that are executable by the one or more processors for causing the one or more processors to perform operations. The operations can include transmitting a first request to a cloud computing environment, the first request being for a total number of records in a batch of records that was processed by the cloud computing environment during a prior time window. The operations can include receiving a first response to the first request, the first response indicating the total number of records in the batch of records. The operations can include transmitting a second request to the cloud computing environment, the second request being for a list of subgroups of records contained within the batch of records. The operations can include receiving a second response to the second request, the second response including the list of subgroups of records. The operations can include executing a partitioned retrieval process for the batch of records, wherein the partitioned retrieval process involves: spawning a number of processing threads; and operating the processing threads in parallel, such that each of the processing threads retrieves one or more of the subgroups of records from the cloud computing environment and saves the one or more subgroups of records to one or more files. The operations can include validating the partitioned retrieval process by determining whether a number of records stored in the one or more files matches the total number of records in the batch of records.

### BRIEF DESCRIPTION OF THE DRAWINGS

FIG. 1 is a block diagram of an example of a system for extracting data from a cloud computing environment according to some aspects of the present disclosure.

FIG. 2 is a block diagram of an example of assignments of subgroups to processing threads according to some aspects of the present disclosure.

FIG. 3 is a sequence diagram of an example of a process for extracting data from a cloud computing environment according to some aspects of the present disclosure.

FIG. 4 is a flowchart of an example of a process for extracting data from a cloud computing environment according to some aspects of the present disclosure.

FIG. 5 is a block diagram of an example of a computing device usable to implement some aspects of the present disclosure.

### DETAILED DESCRIPTION

Cloud computing environments have become increasingly popular for processing and storing data. Even though a cloud computing environment may serve as the primary facility for processing and storing data, it may be desirable to transfer large amounts (e.g., gigabytes or terabytes of data) of the data from the cloud computing environment to a local computing environment, such as an on-premises computing environment. This may allow the local computing environment to perform additional processing or other tasks using the data. But in some contexts, it can be difficult to transfer large amounts of data between the two environments. For example, in high-security contexts, there can be many security restrictions placed on the cloud computing environment and/or the local computing environment to prevent against hacking and other malicious activity. A “high security context” can refer to computer network environments that are governed by stringent security protocols and regulations, typically prevalent in banking and government agencies. These environments can have extensive security measures, limited operational flexibility, and rigorous compliance requirements to ensure the protection and confidentiality of sensitive data and resources. Because of these restrictions, conventional methods of transferring large amounts of data such as using the File Transfer Protocol may be prohibited or severely restricted. And because the data can be very sensitive (e.g., confidential information, PII, and/or proprietary information), sending the data by e-mail or other messaging platforms may also be prohibited. These prohibitions can make it surprisingly challenging to transfer large amounts of data between the two environments.

Some examples of the present disclosure can overcome one or more of the abovementioned problems by providing a way for a local computing environment to extract a large amount of data from a cloud computing environment (or other remote computing environment) in a high-security context, where more common methods may be prohibited. More specifically, the cloud computing environment can be modified to include an application programming interface (API) for use by the local computing environment. The local computing environment can transmit one or more requests to the API for information about a batch of data stored on the cloud computing environment. In response to the one or more requests, the cloud computing environment can provide the information to the local computing environment. The information may indicate an amount of data that is stored in the batch. For example, if the batch is a batch of records, the information can indicate the total number of records in the batch. The batch may also be divided into subgroups, which can be specified in the information. For example, the information can include the total number of subgroups and/or unique identifiers of the subgroups into which the batch is divided. Based on this information, the local computing environment can then execute a retrieval engine. The retrieval engine can spawn processing threads that can execute a partitioned retrieval process in which the processing threads independently retrieve, in parallel to one another, different subgroups from the cloud computing environment via the API. This divides the overall batch retrieval process into smaller parts that are individually handled by the processing threads in parallel to one another. By retrieving the subgroups in parallel, the local computing environment can increase the overall speed with which the batch of data is retrieved.

In some examples, the number of processing threads spawned by the retrieval engine may depend on the total amount of data in the batch and/or the total number of subgroups in the batch. More processing threads may be spawned if there is a larger number of amount of data or subgroups to be retrieved, and fewer processing threads may be spawned if there is a smaller amount of data or subgroups to be retrieved. This can help balance speed and efficiency against resource consumption, because a larger number of processing threads will be faster and more efficient than a smaller number of processing threads, but also consume more computing resources.

In some examples, the data may be encrypted in flight to enhance security. For example, the data may be encrypted by the cloud computing environment before it is transmitted to the local computing environment. The local computing environment can then decrypt the data after it is received. For instance, the subgroups may be encrypted by the cloud computing environment using an encryption key before they are transmitted to the local computing environment. After receiving the subgroups, the retrieval engine can decrypt the subgroups using a corresponding decryption key. Encrypting the data during the transfer process can prevent exposure of the data if it is intercepted.

Using the techniques described above, the local computing environment can retrieve a large amount of data relatively quickly from the cloud computing environment, without having to execute FTP servers or other common file-transfer applications that may be susceptible to attack. These techniques can also be implemented without having to transmit the data by e-mail or other common messaging protocols that may be vulnerable. Encrypting the data in-flight can add a further layer of security by preventing exposure of the data in cleartext format during transfer. Additionally, the above techniques can be implemented fairly easily by adding the API to the cloud computing environment and the retrieval engine to the local computing environment, which requires relatively little to be changed about those environments and allows them to remain compliant with high security protocols.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

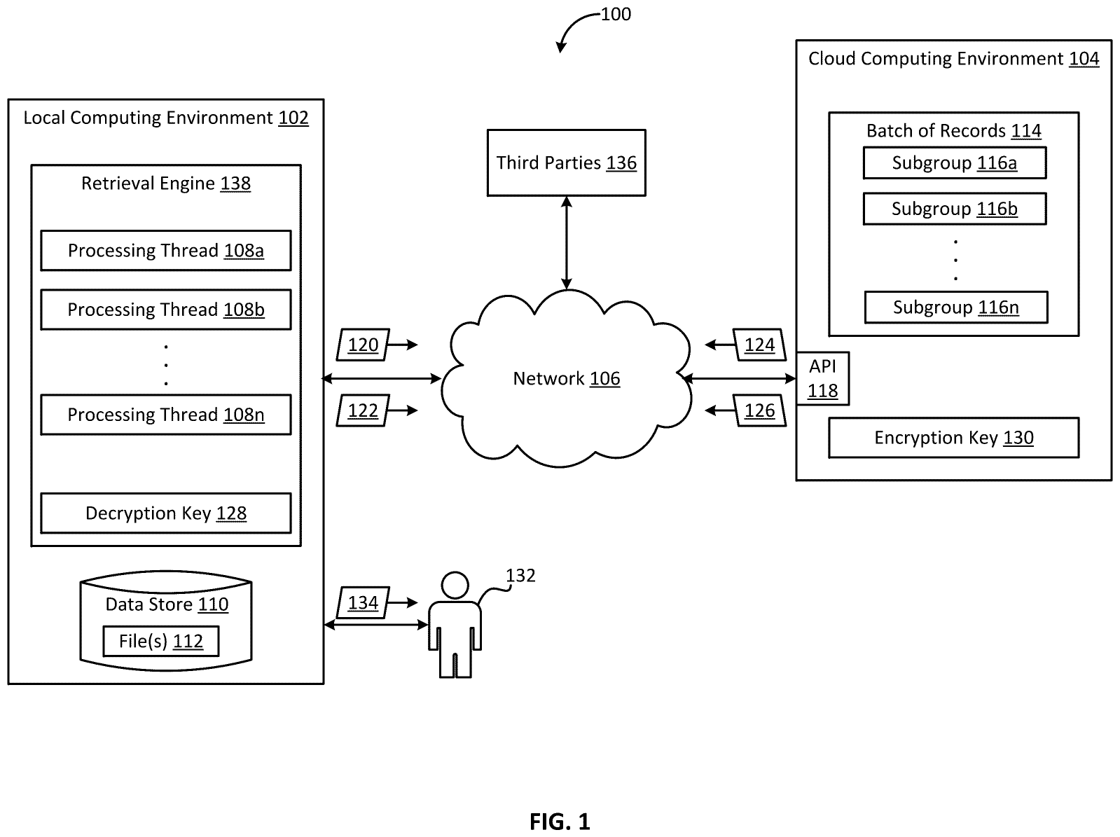

FIG. 1 is a block diagram of an example of a system 100 for extracting data from a cloud computing environment 104 according to some aspects of the present disclosure. The cloud computing environment 104 may include any number and combination of servers, desktop computers, networking equipment, and other devices. Although a cloud computing environment 104 is shown in FIG. 1, it will be appreciated that the techniques described herein could also be applied to other types of remote computing environments other than a cloud computing environment 104.

The cloud computing environment 104 can be used to process and store data. In some examples, the data may be stored as records. For instance, the cloud computing environment 104 could be used to process transactions associated with a bank and records of those transactions could be stored in a database.

In some examples, the cloud computing environment 104 can assign a subgroup to each of the records. A subgroup can be assigned to each record in real time as it is obtained (e.g., received or generated). The subgroup for a given record can be selected according to a predefined partitioning scheme. For example, the cloud computing environment 104 can randomly assign subgroups to records. In this example, each subgroup may be identified by a unique number within a specific range (e.g., 1-5 if there are five subgroups). The cloud computing environment 104 can randomly select a number from this range and assign the corresponding subgroup to a record. At large enough scale, this process will generally result in a roughly even number of records being assigned to each subgroup. In other examples, subgroups can be assigned to records using a round robin technique. For instance, each subgroup can be identified by a unique number within a specific range. The cloud computing environment 104 can then sequentially select numbers from this range to assign subgroups to the records. Assigning a subgroup to each record can help facilitate the extraction of the records by processing threads of the local computing environment 102, as will be described in greater detail later.

The cloud computing environment 104 can be configured with an application programming interface (API) 118. As will be described in greater detail later, the API 118 can be configured to receive requests for data from the local computing environment 102, retrieve the requested data (e.g., from a database), and return the requested data to the local computing environment 102. For security purposes, the API 118 can require authentication (e.g., a username and password) to access the data.

The cloud computing environment 104 can be in communication with the local computing environment 102 via one or more networks 106. The one or more networks 106 can include a private network such as a LAN or a public network such as the Internet. Third parties 136 may also be in communication with the local computing environment 102, the cloud computing environment 104, or both via the one or more networks 106. For instance, the third parties 136 may submit transaction data to the cloud computing environment 104 for processing, which can result in the creation of one or more corresponding records.

For various reasons, it may be desirable for the local computing environment 102 to obtain copies of data (e.g., records) stored in the cloud computing environment 104. For example, the local computing environment 102 may be an on-premises computing environment for an entity that wants to conduct some additional local processing on the data. But if the local computing environment 102 is high security, network administrators may not permit conventional methods of data transfer (e.g., FTP, e-mail, etc.) to be employed in the local computing environment 102. Therefore, another way of transferring the data must be implemented.

To facilitate the data transfer, in some examples the local computing environment 102 can include a retrieval engine 138. The retrieval engine 138 can be configured to implement a partitioned retrieval process to obtain a batch of records 114 or other data from the cloud computing environment 104. The partitioned retrieval process can involve the following steps.

The retrieval engine 138 may begin by determining a total number of records that exist in a batch of records 114 to be downloaded from the cloud computing environment 104. To do so, the retrieval engine 138 may transmit a first request 120 to the API 118 of the cloud computing environment 104, where the first request is for the total number of records in the batch of records 114 to be downloaded. The batch of records 114 can be a set of records that was obtained during a prior time window. In some examples, the batch of records 114 can be large in size—e.g., millions or tens of millions of records. In response to receiving the first request 120, the cloud computing environment 104 can determine the total number of records in the batch of records 114 and transmit a first response 124 indicating the total number of records in the batch of records 114.

The retrieval engine 138 can also determine the subgroups 116a-n that are present in the batch of records 114. For instance, the first response 124 may include a list of the subgroups 116a-n in the batch of records 114, so the retrieval engine 138 can extract the list from the first response 124. Alternatively, the retrieval engine 138 can transmit a second request 122 for the list of subgroups 116a-n to the API 118 of the cloud computing environment 104. In response to receiving the second request 122, the cloud computing environment 104 can transmit a second response 126 that includes the list of subgroups 116a-n to the local computing environment 102.

Next, the retrieval engine 138 can spawn a set of processing threads 108a-n. The number of processing threads 108a-n that are spawned can be based on the amount of data in the batch of records 114. For instance, a new processing thread can be spawned for every set of N records in the batch of records 114, where N can be selected by a user to balance resource consumption against speed. Thus, if there are five million records in the batch of records 114 and N=50000, then 100 processing threads would be spawned to handle the records. Alternatively, the number of processing threads 108a-n that are spawned can be based on the total number of subgroups 116a-n in the batch of records 114. For example, the retrieval engine 138 can spawn a number of processing threads 108a-n that is equal to the total number of subgroups 116a-n, so that there is a 1:1 ratio of processing threads to subgroups. In another example, the number of processing threads can be configured such that there is a 1:2, 1:3, 1:4, or higher ratio of processing threads to subgroups. This ratio may be preselected by a user to balance resource consumption against speed.

The processing threads 108a-n can be loaded with program code that is executable to retrieve their assigned data from the cloud computing environment 104. For example, each of the processing threads 108a-n can be assigned to retrieve one or more of the subgroups 116a-n from the cloud computing environment 104. In this example, the subgroups 116a-n may be evenly assigned to the processing threads 108a-n such that each of the processing threads 108a-n is assigned to handle a roughly equal number of subgroups 116a-n. The processing threads 108a-n can then issue requests for their assigned subgroups 116a-n to the API 118, which can transmit the requested data to the corresponding processing threads 108a-n. As another example, each of the processing threads 108a-n can be assigned to retrieve a respective set of data (e.g., records) from the cloud computing environment 104, independent of any subgroupings assigned by the cloud computing environment 104. In this example, the data in the batch 114 may be evenly assigned to the processing threads 108a-n such that each of the processing threads 108a-n is assigned to handle a roughly equal amount of data (e.g., a roughly equal number of records). The processing threads 108a-n can then issue requests for their assigned subgroups 116a-n to the API 118, which can transmit the requested data to the corresponding processing threads 108a-n. The processing threads 108a-n can save the retrieved data in one or more files 112, which can be stored in a data store 110.

In some examples, the cloud computing environment 104 can encrypt the data using an encryption key 130 prior to transmitting the data to the local computing environment 102. For instance, after receiving a request for a set of records from a processing thread 108a, but before sending the set of records to the processing thread 108a, the cloud computing environment 104 can encrypt the set of records using the encryption key 130. That way, during the transfer process, the records are encrypted just in case they are intercepted (e.g., via a man-in-the-middle attack). After receiving the encrypted records, the processing thread 108a can decrypt the records using a decryption key 128 and store the decrypted records in the one or more files 112. Thus, although the data may be primarily stored in the local computing environment 102 and the cloud computing environment 104 in an unencrypted format, the data can be encrypted during the transfer process for enhanced security.

In some examples, the retrieval engine 138 can perform a “global” validation process in response to determining that all of the processing threads 108a have finished their respective retrieval processes. This can involve comparing the total amount of data in the batch of records 114 to the total amount of data stored in the one or more files 112. For instance, the total number of records in the batch of records 114 may have been previously determined via the first request 120 and can serve as an expected value. The total number of records in the batch of records 114 can be compared to the total number of records stored in the one or more files 112. If the total number of records stored in the one or more files 112 does not match that expected value, it may mean that at least one of the record transfers failed. In response to determining such a mismatch, the retrieval engine 138 can output a failure notification 134 to a user 132. The failure notification 134 can indicate that the partitioned retrieval process at least partially failed. The user 132 may then identify the missing data (e.g., record) using a search process and separately request that data via the API 118, if necessary.

Additionally or alternatively to the global validation, the processing threads 108a-n may each conduct their own individual validation processes. For example, the processing thread 108a may determine how many records exist in each of its assigned subgroups by requesting this information from the cloud computing environment 104 (e.g., via the API 118). The processing thread 108a may then compare the total number of received records for each subgroup to its expected number of records. If the received number of records for a subgroup does not match its expected number of records, it may mean that at least one of the record transfers failed. In response to determining such a mismatch, the retrieval engine 138 can output a failure notification 134 to the user 132. The failure notification 134 can indicate that there was a failure in relation to a particular retrieval process executing on that particular processing thread 108a. The user 132 may then identify the missing record using a search process and separately request that record via the API 118, if necessary.

The retrieval engine 138 can operate the processing threads 108a-n in parallel and be responsible for apportioning data retrieval among the processing threads 108a-n. For instance, the retrieval engine 138 can determine how to assign (e.g., optimally) the subgroups 116a-n to the processing threads 108a-n. Having this central coordinator of the processing threads can help prevent against duplicate downloads of the same data, which would waste computing resources. The decryption key 128 can also remain internal to the retrieval engine 138 and hidden from external software, which can help maintain the security of the system 100.

Using these techniques, a large number of records can be divided into subgroups by the cloud computing environment and downloaded in parallel relatively quickly by the processing threads 108a-n. This can allow a significant amount of data to be transferred from the cloud computing environment 104 to the local computing environment 102, even in high-security contexts. Because the retrieval engine 138 is relatively simple in terms of its functionality and complexity, it is generally less susceptible to vulnerabilities and abuse than more sophisticated file-sharing applications, like FTP servers and mail servers, which may make the retrieval engine 138 preferrable in high-security contexts.

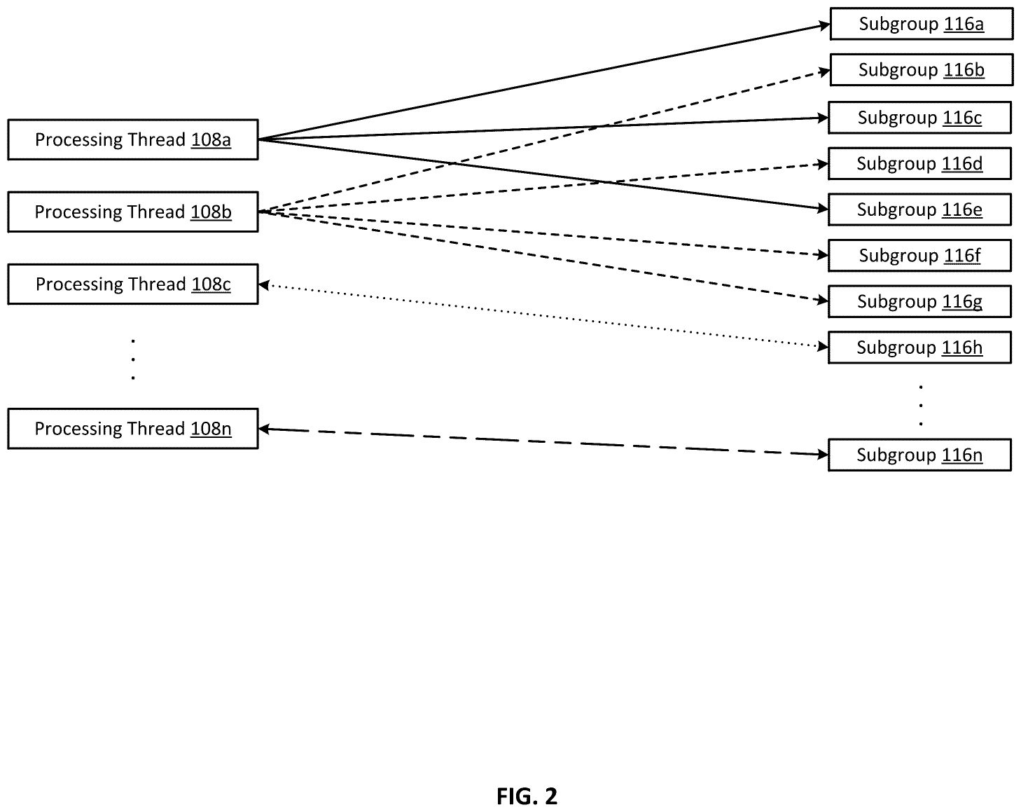

FIG. 2 is a block diagram of an example of assignments of subgroups 116a-n to processing threads 108a-n according to some aspects of the present disclosure. The retrieval engine may assign the various subgroups 116a-n to the processing threads 108a-n for retrieval from the cloud computing environment. In this example, processing thread 108a is assigned subgroups 116a, 116c, and 116e. Processing thread 108b is assigned subgroups 116b, 116d, 116f, and 116g. Processing thread 108c is assigned subgroup 116h. Processing thread 108n is assigned subgroup 116n. Thus, the same or different amounts of the subgroups may be assigned to the processing threads 108a-n.

Each processing thread may handle its assigned subgroups in sequential order. For instance, processing thread 108b may retrieve a first set of records corresponding to its first assigned subgroup 116b, then once that process is complete, retrieve a second set of records corresponding to its second assigned subgroup 116d, then once that process is complete, retrieve a third set of records corresponding to its third assigned subgroup 116f, and so on, until all of its assigned subgroups have been retrieved.

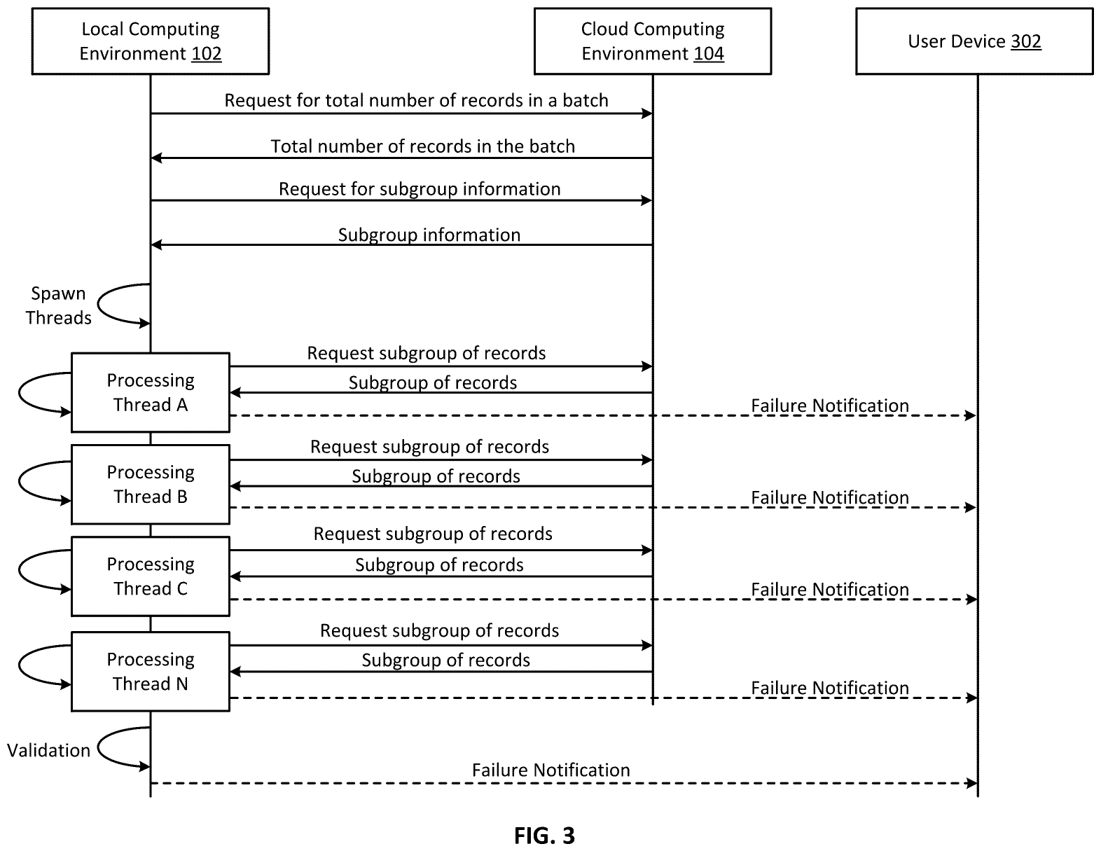

Turning now to FIG. 3, shown is a sequence diagram of an example of a process for extracting data from a cloud computing environment 104 according to some aspects of the present disclosure. Other examples may involve more operations, fewer operations, different operations, or a different order of operations than is shown in FIG. 3.

The process begins with the local computing environment 102 (e.g., a retrieval engine thereon) transmitting a first request to the cloud computing environment 104 for a total number of records in a target batch of records to be downloaded from the cloud computing environment 104. In response to receiving the first request, the cloud computing environment 104 can determine the total number of records in the target batch. The cloud computing environment 104 can then transmit a first response to the local computing environment 102 indicating the total number of records in the batch. The local computing environment 102 can also transmit a second request for information about subgroups in the batch of records. In response to receiving the second request, the cloud computing environment 104 can determine the requested subgroup information. The cloud computing environment 104 can then transmit a second response to the local computing environment 102 indicating the requested subgroup information.

It will be appreciated that although the first and second requests are shown as separate requests in FIG. 3, they may be combined into a single request in other examples. Similarly, the first and second responses may be combined into a single response in other examples. The first and second requests may also be reordered in other examples, such that the request for subgroup information precedes the request for the total number of records in the batch. Use of ordinal terms such as “first”, “second”, “third”, etc., in the claims or description to modify an element is not intended to connote any priority, precedence, or order of one element over another, or the temporal order in which acts of a method are performed. Rather, the ordinal terms are used merely as labels to distinguish one element having a certain name from another element having the same name (but for use of the ordinal term).

Continuing with FIG. 3, the local computing environment 102 can next spawn a number of processing threads. The local computing environment 102 can determine how many processing threads to spawn based on the total number of records in the batch or the total number of subgroups in the batch. Once spawned, the processing threads can execute code to request their assigned subgroups from the cloud computing environment 104. For example, the processing threads A-N can sequentially request their assigned subgroups from the cloud computing environment 104, which can return the requested data to the processing threads A-N. The processing threads A-N can then store the received data (e.g., records) in one or more files.

After receiving the data for one of its assigned subgroups, each processing thread can perform a validation process to confirm that the received data is complete. For example, processing thread A can determine that a record transfer process related to a subgroup has finished. Processing thread A can then compare the number of received records for that subgroup to an expected number of records in the subgroup. If they do not match, processing thread A can generate and transmit a failure notification to a user device 302, such as a laptop computer, desktop computer, mobile phone, or wearable device. The user device 302 can belong to a user who can then take corrective action to resolve the discrepancy. Processing thread A can repeat this validation process for each of its assigned subgroups. Processing threads B-N can perform similar validation processes. That way, each piece of the partitioned retrieval processes is validated in real time as it occurs.

Once all of the processing threads have finished their respective portions of the partitioned retrieval processes, a global validation process can be performed. For example, the local computing environment 102 can determine that the processing threads have finished their respective retrieval processes. Based on determining that the processing threads have finished their respective retrieval processes, the local computing environment 102 can determine a total number of records that were received from the cloud computing environment 104 across all the processing threads. For example, the local computing environment 102 can determine a total number of records stored in the one or more files by the processing threads A-N. The local computing environment 102 can compared the total number of stored records to an expected total number of records, which can be the total number of records in the batch. If they match, then the partitioned retrieval process was successful. If they do not match, then the partitioned retrieval process had a failure of some kind. So, the local computing environment 102 can generate and transmit a failure notification to the user device 302, so that the user can investigate the discrepancy.

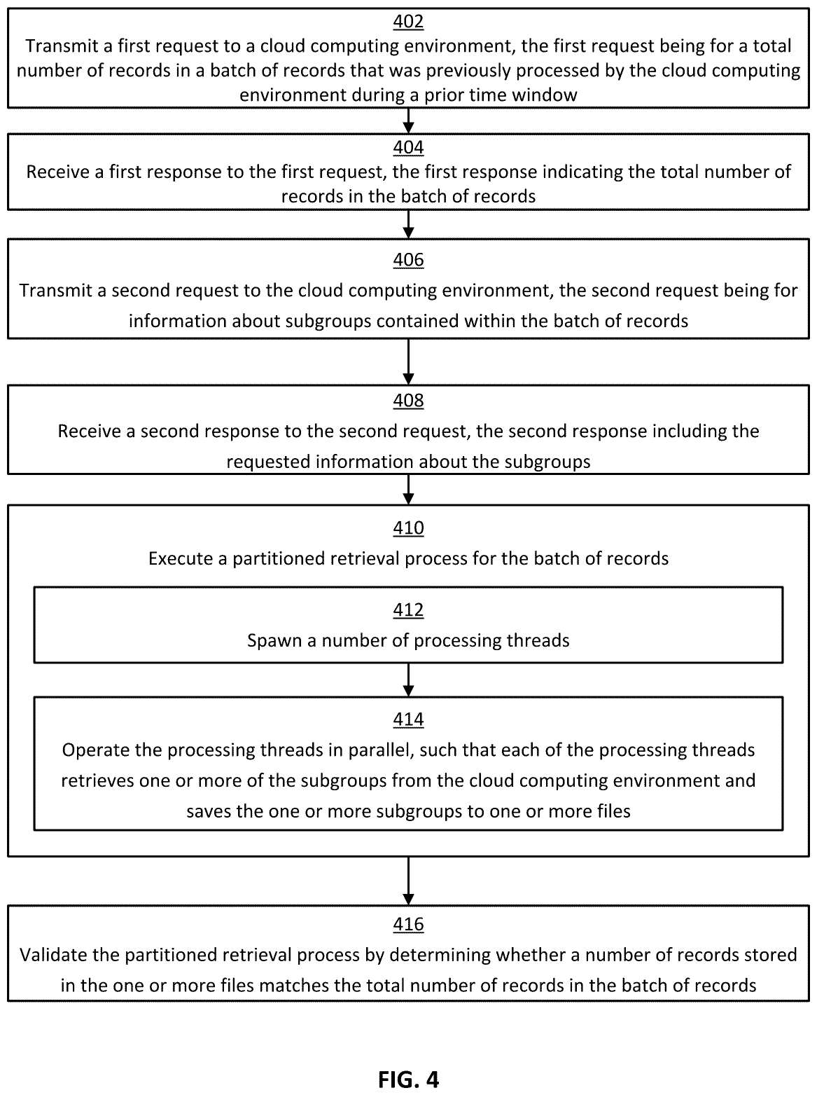

FIG. 4 is a flowchart of an example of a process for extracting data from a cloud computing environment according to some aspects of the present disclosure. Other examples may involve more operations, fewer operations, different operations, or a different order of operations than is shown in FIG. 4. The operations of FIG. 4 are described below with reference to the components of FIG. 1 described above.

In block 402, a retrieval engine 138 transmits a first request 120 to a cloud computing environment 104. In particular, the retrieval engine 138 can transmit the first request 120 to an API 118 of the cloud computing environment 104. The first request 120 can be for a total number of records in a batch of records 114 that was previously processed by the cloud computing environment 104 during a prior time window. In some examples, the first request 120 may indicate the prior time window (e.g., a date range or time range) of interest. In some such examples, the cloud computing environment 104 can determine the prior time window based on the first request 120, identify the batch of records 114 processed during that time window, and determine the total number of records in that batch of records 114.

In block 404, the retrieval engine 138 receives a first response 124 from the cloud computing environment 104. The first response 124 can indicate the total number of records in the batch of records 114.

In block 406, the retrieval engine 138 transmits a second request 122 to a cloud computing environment 104. In particular, the retrieval engine 138 can transmit the second request 122 to the API 118 of the cloud computing environment 104. The second request 122 can be for information about subgroups 116a-n contained within the batch of records 114. For example, the second request 122 can be for a list of subgroups in the batch of records 114. In that example, the cloud computing environment 104 can receive the second request 122 and, in response, analyze the batch of records 114 to determine which subgroups are assigned to the records in the batch 114.

In block 408, the retrieval engine 138 receives a second response 126 from the cloud computing environment 104. The second response 126 can include the requested information about the subgroups contained within the batch of records 114. For example, the second response 126 may include a list of the subgroups in the batch of records 114. Additionally or alternatively, the second response 126 can indicate how many subgroups are in the batch of records 114 and/or how many records are in each subgroup.

In block 410, the retrieval engine 138 executes a partitioned retrieval process for the batch of records 114. The partitioned retrieval process may include blocks 412-414.

In block 412, the retrieval engine 138 spawns a number of processing threads 108a-n (e.g., in the local computing environment 102). The number of processing threads 108a-n may depend on various factors, such as the total number of subgroups in the batch of records 114 and/or the total number of records in the batch of records 114.

In block 414, the retrieval engine 138 operates the processing threads 108a-n in parallel, such that each of the processing threads 108a-n retrieves one or more of the subgroups from the cloud computing environment 104 and saves the one or more subgroups to one or more files 112. This may involve assigning a respective set of subgroups to each respective processing thread. The subgroups may be apportioned among the processing threads 108a-n evenly or unevenly, depending on the circumstances.

In block 416, the retrieval engine 138 validates the partitioned retrieval process (e.g., confirms it was successful). This may involve determining whether the number of records stored in the one or more files 112 matches the total number of records in the batch of records 114. If so, then the retrieval engine 138 can determine that the partitioned retrieval process was successful. Otherwise, the retrieval engine 138 can determine that the partitioned retrieval process failed. In response, the retrieval engine 138 may generate and output a failure notification 134. The failure notification 134 may be sent to a user 132, who can take further action to resolve the problem.

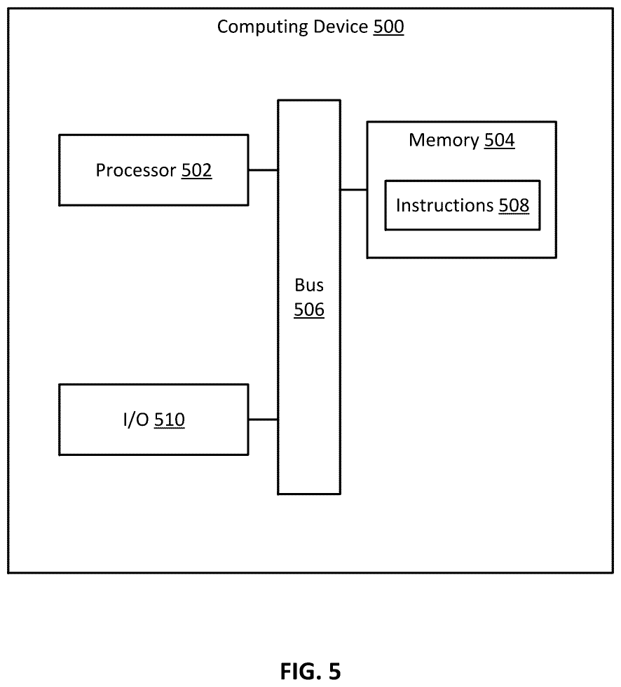

Turning now to FIG. 5, shown is a block diagram of an example of a computing device 500 usable to implement some aspects of the present disclosure. In some examples, the computing device 500 may be part of the local computing environment 102 of FIG. 1.

The computing device 500 includes a processor 502 communicatively coupled to a memory 504 by a bus 506. The processor 502 can include one processor or multiple processors. Examples of the processor 502 can include a Field-Programmable Gate Array (FPGA), an application-specific integrated circuit (ASIC), or a microprocessor. The processor 502 can execute instructions 508 stored in the memory 504 to perform operations. The instructions 508 may include processor-specific instructions generated by a compiler or an interpreter from code written in any suitable computer-programming language, such as C, C++, C#, Java, or Python.

The memory 504 can include one memory device or multiple memory devices. The memory 504 can be volatile or non-volatile (e.g., it can retain stored information when powered off). Examples of the memory 504 include electrically erasable and programmable read-only memory (EEPROM), flash memory, or cache memory. At least some of the memory 504 includes a non-transitory computer-readable medium from which the processor 502 can read instructions 508. A computer-readable medium can include electronic, optical, magnetic, or other storage devices capable of providing the processor 502 with the instructions 508 or other program code. Examples of a computer-readable mediums include magnetic disks, memory chips, ROM, random-access memory (RAM), an ASIC, a configured processor, and optical storage.

The computing device 500 also includes input/output components 510. Examples of input components can include a mouse, a keyboard, a touchpad, a touch-screen display, a global positioning system (GPS) unit, a gyroscope, an accelerometer, an inclinometer, and a camera. Examples of output components can include a visual display, a haptic display, and an audio display. Examples of a visual display can include a liquid crystal display (LCD) or a light-emitting diode (LED) display. Examples of a haptic display can include a haptic actuator, such as an eccentric rotating mass (ERM) vibration motor. Examples of an audio display can include a speaker system.

The above description of certain examples, including illustrated examples, has been presented only for the purpose of illustration and description and is not intended to be exhaustive or to limit the disclosure to the precise forms disclosed. Numerous modifications, adaptations, and uses thereof will be apparent without departing from the scope of the disclosure. For instance, any examples described herein can be combined with any other examples to yield further examples.

1. A non-transitory computer-readable medium comprising program code that is executable by one or more processors for causing the one or more processors to perform operations including:
determining a number of subgroups into which a batch of data is divided in a remote computing environment; and
executing a partitioned retrieval process for the batch, wherein the partitioned retrieval process involves:
determining a number of processing threads to spawn based on the number of subgroups associated with the batch;
spawning the number of processing threads;
assigning a respective set of the subgroups to each of the processing threads; and
operating the processing threads in parallel, such that each of the processing threads retrieves its respective set of subgroups from the remote computing environment and saves the respective set of subgroups to one or more files.

2. The non-transitory computer-readable medium of claim 1, wherein each processing thread is configured to:
for each subgroup of its respective set of subgroups:
comparing an expected amount of data for the subgroup to a received amount of data for the subgroup; and
in response to determining that the expected amount of data does not match the received amount of data, outputting a failure notification.

3. The non-transitory computer-readable medium of claim 1, wherein operations further comprise:
validating the partitioned retrieval process by determining whether a total amount of data stored in the one or more files matches an expected total amount of data in the batch; and
in response to determining that the total amount of data stored in the one or more files does not match the expected total amount of data in the batch, outputting a failure notification.

4. The non-transitory computer-readable medium of claim 3, wherein operations further comprise:
transmitting a request to the remote computing environment for the total amount of data in the batch; and
receiving a response to the request from the remote computing environment indicating the total amount of data in the batch.

5. The non-transitory computer-readable medium of claim 1, wherein operations further comprise:
transmitting a request to the remote computing environment for the number of subgroups in the batch; and
receiving a response to the request from the remote computing environment indicating the number of subgroups in the batch.

6. The non-transitory computer-readable medium of claim 1, wherein the subgroups are encrypted by the remote computing environment before being transmitted to the processing threads, and wherein the processing threads are configured to:
retrieve the encrypted subgroups from the remote computing environment;
decrypt the encrypted subgroups using a decryption key; and
save the decrypted subgroups to the one or more files.

7. The non-transitory computer-readable medium of claim 1, wherein the remote computing environment is configured to divide the batch into the subgroups using a predefined partitioning scheme.

8. A computer-implemented method comprising:
determining a number of subgroups into which a batch of data is divided in a remote computing environment; and
executing a partitioned retrieval process for the batch, wherein the partitioned retrieval process involves:
determining a number of processing threads to spawn based on the number of subgroups associated with the batch;
spawning the number of processing threads;
assigning a respective set of the subgroups to each of the processing threads; and
operating the processing threads in parallel, such that each of the processing threads retrieves its respective set of subgroups from the remote computing environment and saves the respective set of subgroups to one or more files.

9. The method of claim 8, wherein each processing thread is configured to:
for each subgroup of its respective set of subgroups:
comparing an expected amount of data for the subgroup to a received amount of data for the subgroup; and
in response to determining that the expected amount of data does not match the received amount of data, outputting a failure notification.

10. The method of claim 8, further comprising:
validating the partitioned retrieval process by determining whether a total amount of data stored in the one or more files matches an expected total amount of data in the batch; and
in response to determining that the total amount of data stored in the one or more files does not match the expected total amount of data in the batch, outputting a failure notification.

11. The method of claim 8, further comprising:
transmitting a request to the remote computing environment for the total amount of data in the batch; and
receiving a response to the request from the remote computing environment indicating the total amount of data in the batch.

12. The method of claim 8, further comprising:
transmitting a request to the remote computing environment for the number of subgroups in the batch; and
receiving a response to the request from the remote computing environment indicating the number of subgroups in the batch.

13. The method of claim 8, wherein the subgroups are encrypted by the remote computing environment before being transmitted to the processing threads, and wherein the processing threads are configured to:
retrieve the encrypted subgroups from the remote computing environment;
decrypt the encrypted subgroups using a decryption key; and
save the decrypted subgroups to the one or more files.

14. The method of claim 8, wherein the remote computing environment divides the batch into the subgroups using a predefined partitioning scheme, prior to the partitioned retrieval process being executed.

15. A system comprising:
one or more processors; and
one or more memories storing instructions that are executable by the one or more processors for causing the one or more processors to perform operations including:
determining a number of subgroups into which a batch of data is divided in a remote computing environment; and
executing a partitioned retrieval process for the batch, wherein the partitioned retrieval process involves:
determining a number of processing threads to spawn based on the number of subgroups associated with the batch;
spawning the number of processing threads;
assigning a respective set of the subgroups to each of the processing threads; and
operating the processing threads in parallel, such that each of the processing threads retrieves its respective set of subgroups from the remote computing environment and saves the respective set of subgroups to one or more files.

16. The system of claim 15, wherein each processing thread is configured to:
for each subgroup of its respective set of subgroups:
comparing an expected amount of data for the subgroup to a received amount of data for the subgroup; and
in response to determining that the expected amount of data does not match the received amount of data, outputting a failure notification.

17. The system of claim 15, wherein operations further comprise:
validating the partitioned retrieval process by determining whether a total amount of data stored in the one or more files matches an expected total amount of data in the batch; and
in response to determining that the total amount of data stored in the one or more files does not match the expected total amount of data in the batch, outputting a failure notification.

18. The system of claim 17, wherein operations further comprise:
transmitting a request to the remote computing environment for the total amount of data in the batch; and
receiving a response to the request from the remote computing environment indicating the total amount of data in the batch.

19. The system of claim 15, wherein operations further comprise:
transmitting a request to the remote computing environment for the number of subgroups in the batch; and
receiving a response to the request from the remote computing environment indicating the number of subgroups in the batch.

20. The system of claim 15, wherein the remote computing environment is configured to divide the batch into the subgroups using a predefined partitioning scheme, prior to the partitioned retrieval process being executed.
